(19) United States
(12) Patent Application Publication
(10) Pub. No.: US 2012/0133667 A1
(43) Pub. Date: May 31, 2012

(54) METHOD AND APPARATUS FOR DESIGNING, STYLIZING, AND SUPPLEMENTING AN IMAGE/SCENE

(75) Inventor: Joseph N. Lachoff, Oakland, CA (US)

(73) Assignee: AUTODESK, INC., San Rafael, CA (US)

(21) Appl. No.: 13/306,758

(22) Filed: Nov. 29, 2011

Related U.S. Application Data
(60) Provisional application No. 61/418,168, filed on Nov. 30, 2010.

(51) Int. Cl. G09G 5/02; G09G 5/00

(52) U.S. Cl. 345/589; 345/581

(57) ABSTRACT

A method, apparatus, system, article of manufacture, and computer program product provide the ability to utilize scene elements in a computer drawing application. A modeling scene is obtained. The user searches for and selects a pattern scene that includes an environment attribute. The environment attribute is selected and retrieved from the pattern scene to be used in the modeling scene.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/418,168, filed on Nov. 30, 2010, by Joseph N. Lachoff, entitled “SCENE/IMAGE DESIGN ENGINE,” attorneys' docket number 30566.452-US-P1.

### BACKGROUND OF THE INVENTION

1. Field of the Invention

The present invention relates generally to computer images, and in particular, to a method, apparatus, system, and article of manufacture for efficiently and easily designing/improving the visual appearance of a scene, image, and/or drawing.

2. Description of the Related Art

When designing/creating a scene, image, model, web page, or drawing (collectively referred to herein as a “scene”), a user/designer can often create certain objects/designs. However, the context and details of the environment surrounding the object may extend beyond the user's/designer's expertise. Nonetheless, the user may still desire to present a visually/aesthetically appealing rendering of the scene. The prior art fails to provide a mechanism for easily and efficiently rendering a scene that not only contains a user's design objects, but that also presents such design objects in a visually appealing manner. Such problems may be better understood with an explanation of prior art design/modeling/drawing applications.

Users often don't consider themselves to be stylists or people that have a knowledge base for creating a visually/aesthetically appealing rendering. However, users still desire to provide such a rendering. For example, a user may know how to design a sheet metal donut factory or build a foundation, an MP3 player, etc. but may lack the capability and desire to present a rendering of such a design that looks “good”. In another example, a user may have a personal website for photography with photographs on the web page, however, the user may not have the knowledge base to create a website and presentation that is rendered around the photographs.

To create a visually/aesthetically pleasing 3D rendering, users may assign materials/textures to objects in a scene. However, such an assigning may be too granular of an activity. Accordingly, many users want their projects to look good, but don't want to spend a lot of time getting materials and lighting just right for a particular project. If the environment settings for a scene were done/available ahead of time, the user could save considerable time when creating the rendering.

Some prior art products such as RapidWeaver™, IWeb™, IDVD™, and others provide templates that assist the user with the creation of a website and/or DVD. However, a predefined set of templates that force the user to select and utilize a single complete template when developing a 3D rendering is very limiting. In this regard, a user is forced to elect a particular template before designing the rendering/end product (i.e., the template cannot be applied to an already existing website, drawing, model, etc.). In addition, prior art implementations require a user to select a single template before designing a scene and fail to provide the flexibility to select multiple templates (or portions of multiple templates) at any time during the scene creation process.

Accordingly, what is needed is a mechanism for easily and efficiently stylizing/supplementing images/scenes.

### SUMMARY OF THE INVENTION

Embodiments of the invention provide for a “pattern book” that provides complete setups that include lighting, materials, environments, and properties. Rather than browsing a large collection of materials, lighting set-ups, etc., to begin with, the user browses a pattern book, looking for images that most closely resemble the “look” the user is attempting to emulate. When the user finds a suitable pattern photograph, the user can load the pattern and select materials/objects for his/her scene directly from objects in the pattern photograph.

Accordingly, embodiments of the invention provide the ability for users to select settings and objects from available scenes/images and incorporate such settings/objects into their own scene on an ad-hoc and individual basis.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates the task flow for the creation of exemplary presentation boards in accordance with one or more embodiments of the invention; and

FIG. 4 is a flow chart illustrating the logical flow for utilizing scene elements in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

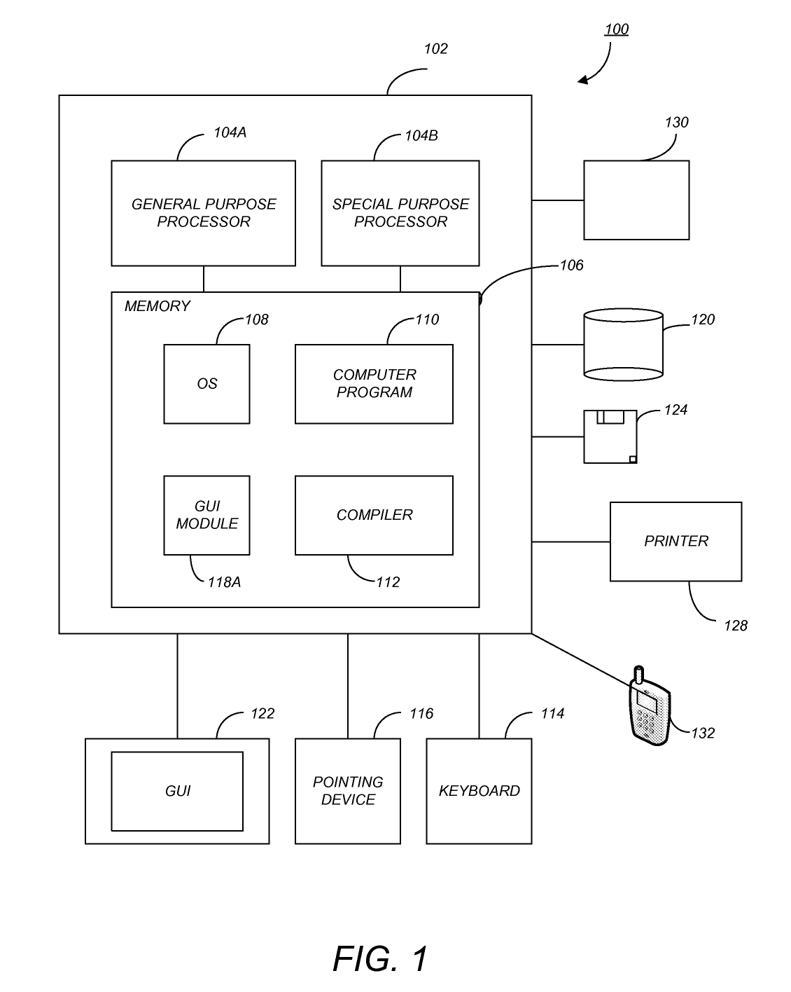

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to other devices, including input/output (I/O) devices such as a keyboard 114, a cursor control device 116 (e.g., a mouse, a pointing device, pen and tablet, etc.) and a printer 128. In one or more embodiments, computer 102 may be coupled to a media viewing/listening device 132 (e.g., an MP3 player, iPod™, Nook™, portable digital video player, cellular device, personal digital assistant, etc.).

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108 to provide output and results.

Output/results may be presented on the display 122 or provided to another device for presentation or further processing or action. In one embodiment, the display 122 comprises a liquid crystal display (LCD) having a plurality of separately addressable liquid crystals. Each liquid crystal of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118A. Although the GUI module 118A is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of a multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 102 may also implement a compiler 112 which allows an application program 110 written in a programming language such as COBOL, Pascal, C++, FORTRAN, or other language to be translated into processor 104 readable code. After completion, the application or computer program 110 accesses and manipulates data accepted from I/O devices and stored in the memory 106 of the computer 102 using the relationships and logic that was generated using the compiler 112.

The computer 102 also optionally comprises an external communication device such as a modem, satellite link, Ethernet card, or other device for accepting input from and providing output to other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program instructions which, when accessed, read and executed by the computer 102, causes the computer 102 to perform the steps necessary to implement and/or use the present invention or to load the program of instructions into a memory, thus creating a special purpose data structure causing the computer to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 102.

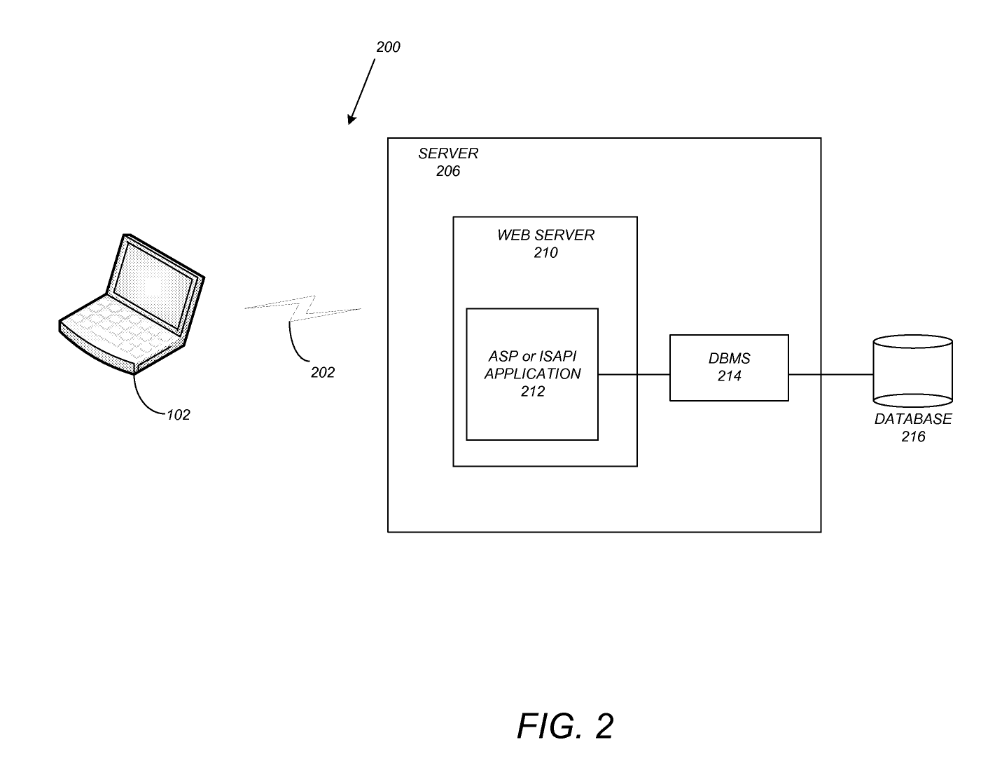

FIG. 2 schematically illustrates a typical distributed computer system 200 using a network 202 to connect client computers 102 to server computers 206. A typical combination of resources may include a network 202 comprising the Internet, LANs (local area networks), WANs (wide area networks), SNA (systems network architecture) networks, or the like, clients 102 that are personal computers or workstations, and servers 206 that are personal computers, workstations, minicomputers, or mainframes (as set forth in FIG. 1).

A network 202 such as the Internet connects clients 102 to server computers 206. Network 202 may utilize ethernet, coaxial cable, wireless communications, radio frequency (RF), etc. to connect and provide the communication between clients 102 and servers 206. Clients 102 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, etc. Further, the software executing on clients 102 may be downloaded from server computer 206 to client computers 102 and installed as a plug in or ACTIVEX™ control of a web browser. Accordingly, clients 102 may utilize ACTIVEX™ components/component object model (COM) or distributed COM (DCOM) components to provide a user interface on a display of client 102. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 102 instead of communicating/obtaining the information from database 216 across network 202. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from a device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the term “user computer”, “client computer”, and/or “server computer” is referred to herein, it is understood that such computers 102 and 206 may include portable devices such as cell phones, notebook computers, pocket computers, or any other device with suitable processing, communication, and input/output capability.

Of course, those skilled in the art will recognize that any combination of the above components, or any number of different components, peripherals, and other devices, may be used with computers 102 and 206.

### Software Embodiments

Embodiments of the invention are implemented as a software application on a client 102 or server computer 206. Further, embodiments of the invention allow the user to browse the Internet 202 (using a client 102) to find scenes containing desirable properties, settings, or objects that the user can utilize in his/her own scene/image/model/etc. In addition, photographs may be available as part of a collection referred to as a “pattern book”.

Each image located in the “pattern book” or found on a network may or may not provide a complete setup that includes lighting, materials, environments and properties. In this regard, any given image may contain only a subset of the complete content supported by a system of the invention. For example, image A may contain a complete setup, but image B may contain just some materials. The content available for each image is at the discretion of the image's publisher/author. Rather than browsing a large collection of materials to begin with (e.g., on the Internet 202), the user/client 102 browses the pattern book, looking for images that most closely resemble the “look” desired. When the user finds a suitable pattern photograph, the pattern can be loaded and materials can be selected for use in the user's scene (directly from objects in the pattern photo). In this regard, an object(s) itself (and not merely a reference to the object) can be directly selected and utilized in the scene. Alternatively, a user can browse photographs/models/images on the Internet 202 and select patterns and materials from any found photograph/model/image.

A user can also select more than one pattern to work from—using one for lighting, one for environment, another for properties, and perhaps several others for material samples. The point is to select information/patterns from scenes that are already set up to look great by professionals. The user can insert elements from the pattern book scenes into a design, and then customize the design, if desired. Such an approach provides the user with a better opportunity to create a visually/aesthetically pleasing scene/image (i.e., compared to a non-creative user's ability to create such a scene from scratch).

In addition to selecting properties/materials from a pattern book, embodiments of the invention may also enable the use of additional properties that can be combined with the properties/materials from the pattern book, and/or manually manipulated by the user. For example, a user may select multiple materials from the pattern book, and lighting parameters may be added (i.e., to be combined with and/or manually manipulated by the user). The method and manner in which different properties are combined with each other may vary depending on the property and materials selected. Further, a pre-defined set of parameters/settings (referred to as a “setup”) can be added/selected by the user. For example, if a particular material is selected by the user from the pattern book, an average lighting setup may be automatically (e.g., without any additional user input) utilized to provide the best overall look (for the given material selected and the light options required). In addition, the user can define which aspects (e.g., settings, parameters, etc.) are available (e.g., for others or for the same user to select at another time).

In view of the above, embodiments of the invention provide that each scene may include a controlled set of content that a user can re-purpose, while also providing the ability to limit the content that is exposed (e.g., such that not all of the content from the original file is available). For example, any file from any application (or any application that is configured in accordance with the invention) may be “renderable” to a pattern book scene file. Such a pattern book scene file can then be viewed and/or used by others in their own scene/image (i.e., in accordance with privacy/security settings). Accordingly, the controlled set of content can be repurposed and are part of the pattern book scene file while actual geometry and/or objects may not be part of the pattern book scene file. By dividing the settings (i.e., the “setup”) from the geometry/objects of a scene, the entire model which includes both settings and proprietary information does not need to be exposed. Instead, the user has the option of only exposing information that the user has specified. Thus, users who are experts at creating great looking 3D scenes may be encouraged to share their “setups” without risking the exposure/availability/theft of their proprietary model information.

Another way to view the division of geometry from the settings/parameters is by comparing the division to printing to PDF (portable document format). When printing to PDF, various aspects can be locked down so that the content is controlled. The scene files (i.e., for the pattern book) would only contain the data for materials, lighting, environments, and any “entourage” models that the author specifies to share, plus the high resolution preview render of what the scene looks like rendered. Such a rendering may be read only within a pattern book user interface component, and/or could be made available via an online library/catalog (e.g., Autodesk™ Seek™ [an online source for product specification and design files available from the assignee of the present invention]) and/or on any user forum where people can exchange content.

In view of the above, embodiments of the invention may be viewed as the ability to allow users to browse the Internet or other locations and harvest images and/or settings from found images and utilize/insert such images/settings in their own scene. The images/settings that are being harvested may also have security controls established by the person/entity authoring such images/settings. For example, the author may designate certain objects/settings as being publicly accessible/sharable while other objects/settings are not exposed or available. Thus, a user may specify that the environment settings are public but the underlying sheet metal design of an engine component is private.

Further, each content type in the scene may be given its own “Creative Commons” license type, such that the user can allow different types of usage for different elements. A “Creative Commons” license is a license that provides flexible options for defining a specific set of rights associated with the elements in the license. Users can define a “Creative Commons” license to include a set (or subset) of the rights available under copyright law. As an example, a “Creative Commons” license may provide the ability to license a work under one or more of the following conditions/terms: attribution (allowing others to copy, distribute, display, and perform the copyrighted work, and derivative works based upon on it, but only if they provide the author credit), noncommercial (allowing others to copy, distribute, display and perform a work, and derivative works, but only for noncommercial purposes), no derivative works (allowing others to copy, distribute, display and perform only verbatim copies of the work, not derivative works based upon it), and/or share alike (allowing others to distribute derivative works only under a license identical to the license that governs the author's work). The use and conditions of such a license may encourage users to participate in a content publishing community for the objects/settings.

In addition, different levels of security may also be established. For example, a user may specify that certain objects/settings are available to one group/type of user, while other objects/settings are available to a different group/type of user, while additional objects/settings are private. Accordingly, the user/author may establish a variety of types of security levels or access controls over the data for their scene.

In view of the above, the basic concept of one or more embodiments of the invention is to provide the ability to utilize lighting setups, materials, and any other attributes/settings while restricting access (if desired) to the geometry itself. Such settings may include camera settings (e.g., focal length, aperture, camera angle, etc.), lighting setups (e.g., settings for setting up lighting in the real world, 3D settings, etc.), background settings (e.g., transparency levels, layer settings, etc.), and/or color information (e.g., contrast, brightness, gamma, luminance, resolution, video gain, color depth, etc.).

### User Scenario/Use Case

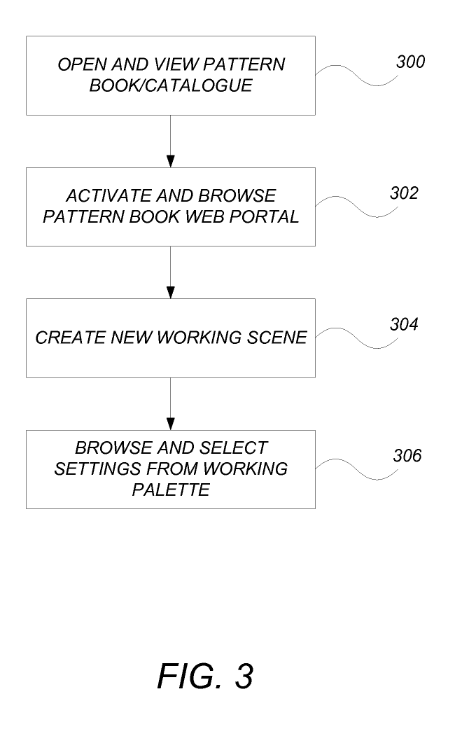

Assume an employee works at an electronics manufacturer and has designed/created/modeled a new portable MP3 player design using a solid modeling application. The employee now needs to create an array of presentation boards exploring finish and suggesting the brand experience. FIG. 3 illustrates the task flow for the creation of such presentation boards in accordance with one or more embodiments of the invention.

Task Flow

1. At step 300, the employee opens the pattern book/catalogue user interface (UI) and pages through the current patterns. Step 300 may include multiple sub-steps as described below.
a. The employee scans a grid of scenes in the pattern book/catalogue—many are photo-realistic renderings of other projects, but some are buildings, environments, even some abstract settings;
b. The employee selects a scene that catches his/her eye and enlarges the image full screen to have a closer look;
c. Now in full screen mode, the employee continues to page through the pattern book/catalog, scene by scene;
d. The employee selects a scene that has an aluminum and rubber exercise bike in a bright, sun-lit room—the materials might work, but the user does not fancy the environment. Nonetheless, the employee may add the scene to his/her working pattern palette (i.e., a private [or public] palette/catalogue/listing containing selected images/scenes);
e. The employee browses onward and adds another scene to the working pattern palette with a flower vase on a glossy white countertop; and
f. The employee selects two to three other scenes (that are added to the working pattern palette) with environments, materials, lighting and props that might work.

2. The employee reviews the grid of five (5) selected scenes on the private/personalized working pattern palette. The employee decides to look at more scenes, and at step 302, activates a pattern book web portal directly from this context.
a. Now in a web browser, the employee searches the portal and browses the results, selecting scenes of interest while browsing, including the interior of a sporty car, a sailboat deck with rigging, and a hip toon-shaded scene with flat colors; and
b. The employee downloads and installs the new scenes into the working palette and/or pattern book/catalogue.

3. At step 304, the employee creates a new working scene in the solid modeling application. At step 306, the employee refines the presentation in the model by browsing and selecting settings from the working palette while also adjusting the geometry/objects (as well as the imported/selected settings) in the model.
a. To begin with, the MP3 player is in the scene, but nothing else is in the scene—similar to the modeling environment;
b. The employee browses the working pattern palette and selects a lighting and environment from one of the scenes therein;
   i. The new scene is updated to reflect selected choices;
c. The employee adds the shiny white counter top to his scene;
d. The employee adjusts the objects in the scene, positioning the MP3 player to get a nice reflection on the countertop;
e. The employee uses tools in the scene environment to extract specific individual materials from various scenes in the working pattern palette, applying them to the MP3 player;
f. The yellow rubber surface from one of the scenes is the perfect texture, but the employee wants to use the exact Pantone yellow the electronics company prefers. Accordingly, the employee edits the yellow rubber material in the working scene to make the color correction;
g. Satisfied with the scene, the employee renders it to get a high definition preview. Perfect!

4. Working in a similar fashion, the employee quickly develops two more variations on materials in the same setting.

5. Finally, working through the same process, the employee develops two more environments to show each of his/her three (3) material variations, but now in different contexts. Before lunch, the employee has nine (9) presentation boards ready to review with the team.

6. Later, following the review session, the employee adjusts the button spacing on the face of the MP3 player in the main model. The nine (9) scenes are rerendered, in which the scenes automatically inherit the revised button spacing.

### Embodiment Options

In one or more embodiments of the invention, a modified version of an existing common graphics file format, such as JPEG or PNG, albeit enriched with custom header sections that would contain the proprietary data may be utilized. Using such a file format, users can display the preview in any web browser without needing a special viewer, thereby streamlining the workflow. A valuable aspect of the use of common graphics file formats is that these files can be published on any web site, and consequently they will be indexed and searchable by any Internet search engines (e.g., Google™, etc.). Alternatively, users may further be allowed to merely use a search engine to search the web for compelling images with results that will have extractable scene data in them.

In yet another embodiment, an application of the invention may generate materials, lighting and environments from any photographic image found on the web, though the use of various image analysis algorithms.

Using a common graphics file format, the file appears as a photograph/image and may be loaded by standard applications such as web browsers. To utilize such a format, the application creating the file would render/export the image to the common/standard format desired. Once rendered/exported, the image itself would only contain the bitmap data. However, custom headers may be embedded into the file. Such custom headers may contain some or all of the materials, settings, or attributes that the user desires to share. Accordingly, the user can specify which non-proprietary objects to embed while not specifying the proprietary objects/attributes. Similarly, different security levels may also be used/specified in the customized headers. Thus, users can embed any type of information that a product offers (e.g., lighting setups, camera setups, sound information, HTRI [heat transfer research institute] images/environmental data, etc.).

As an example, if a user designs a telephone object that is being rendered in the scene on top of a desk next to flowers. The user can opt to embed the desk and flowers and environmental information relating to the rendering of the information but not embed the geometry for the telephone object itself.

As an alternative to embedding the data directly in header information, embodiments of the invention may also embed pointers to the data in the header. In such an embodiment, a lightweight version of the file is rendered that contains only the non-proprietary (or proprietary) info (e.g., the bitmap data itself). The pointers may point to a uniform resource locator (URL) or other location on any type of network that contains the actual data/information. When a subsequent user elects to utilize such data, the pointers are followed and the data can be retrieved (or can remain remote but accessible). The actual data can be managed on a remote server in a proprietary manner with security/access restrictions as desired (e.g., that change on a time basis, person basis, entity basis, location basis, etc.).

When rendering the data from an application, embodiments of the invention may provide a user interface with the ability to indicate which data is to be made public/shared. For example, a list of objects/attributes/properties may be displayed with checkboxes adjacent to each that a user can utilize to indicate the desired access. In such an embodiment, the user can easily check a box adjacent to each object to indicate the public access level/status of that object/property. Private data may be stored locally on the hard drive while public data may be stored in the cloud and pointed to (e.g., using a URI in the header). Accordingly, when saving/rendering a document, all non-proprietary information (e.g., definitions for materials, etc.) may be segmented off and stored in a cloud with pointers stored in the header.

As an alternative, embodiments of the invention may utilize automatically created metadata. For example, a digital camera may automatically create metadata identifying parameters used by the camera (e.g., aperture setting, internal camera setting, GPS location, etc.) and embed such data into the file/picture. Alternatively, the photographer/author of a file may create metadata that is to be embedded or linked to by a given image/rendering. Thus, the metadata identifies the publicly accessible data for an image/model/scene. The metadata may be in any format (e.g., XML) and can be interchangeably utilized across multiple different applications/platforms (e.g., Linux™, Apple™, or Microsoft™ based systems or a solid modeling application, 2D drawing application, and/or special effects application). The format in which the metadata is published may be in an open format such that search engines are capable of indexing images with the metadata and make such images findable by users within a search engine.

As described above, in addition to using a selected set of images in a book of available patterns, any digital image the user can find (on the web, or from a digital photograph taken on site, for example) can be used as an input for creating a customized pattern.

In addition to the above, different items from different files may be used. For example, the lighting setup from one file and the sound setup from another file may be selected and utilized by a user in creating a new image they desire to render.

Materials may also be automatically assigned based on object parameters (flooring applied to floor; paint applied to walls; etc).

Further, embodiments may provide/enable an online community content sharing project. In such a project, if a user has created a gorgeous pattern, it may be shared (or even sold) online.

### Logical Flow

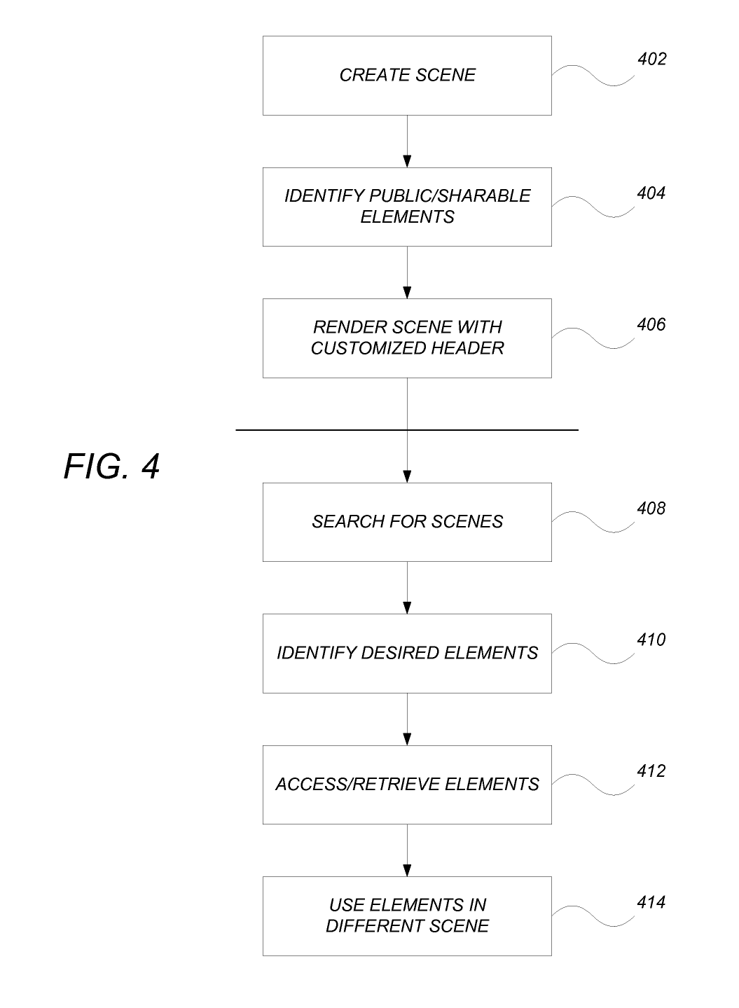

FIG. 4 is a flow chart illustrating the logical flow for utilizing scene elements in accordance with one or more embodiments of the invention. Steps 402-406 are performed by a first author of various scene elements to establish publicly accessible scene elements from a first scene. Steps 408-414 are performed by a second author of a second different scene desiring to use publicly accessible elements from/of the first scene.

At step 402, a scene is obtained (e.g., either created or retrieved) by a first author. Such scene may contain geometry, environment settings, lighting setups, etc. In this regard, any type of attribute/setting for the scene available from a product creating the scene may be created.

At step 404, the first author identifies the elements (e.g., environment attributes) in the scene that are to be publicly accessible/sharable. As described above, such public access may mean publicly accessible within a particular intranet network or may be accessible to the public at large. Such elements include any setting/attribute for the application used to create the scene. For example, the elements/environment attributes may include a lighting setup, a camera setting, a background setting, and/or color information. Further, the first author can merely check boxes to indicate which elements/objects are to be public/sharable.

At step 406, the first author renders the scene with a customized header. The format of the rendered scene may be a commonly used/standard format such as PDF, JPG, PNG, etc. The customized header contains embedded information. The embedded information enables the retrieving of selected environment attributes/elements. Thus, the embedded information may be the actual public objects/attributes/elements. Alternatively, the embedded information may be a link to a location containing the public/sharable information/elements. Further, in one or more embodiments, only those properties identified to be shared may be embedded or available for additional use by different users/authors. Accordingly, if not identified as sharable (e.g., geometry), such non-identified content is restricted from retrieval and use from the scene (i.e., by future users/authors).

At step 408, a second author searches for scenes (i.e., pattern scenes) in order in import desired objects/attributes/properties from one or more scenes. As used herein, the objects/attributes/properties may be referred to as environment attributes (distinguishable from geometry of the drawing/model). As described above, the second author may search general images on the Internet or may search a subset of items/images within a “pattern book” available to the second author.

At step 410, the second author identifies/selects the elements (i.e., environment attributes) he/she desires to utilize in his/her own scene. The second author may select check boxes, drag and drop, or any other functionality available to actually select desirable elements/objects/attributes. As part of this process, the second author may establish a working library/pattern palette with objects/attributes/properties from any images/scenes found. Such a working library/pattern palette may therefore consist of a subset of pattern scenes that are personalized/personally selected by the second user/author. The second author can then use the working library/pattern palette to import/incorporate the objects/attributes/properties directly into their own scene.

At step 412, the desired elements are accessed/retrieved by the second author (e.g., by dragging an object/property/setting from a library/image into the scene the author is creating).

At step 414, the retrieved elements are used in the second/different scene (referred to as the modeling scene). Thus, the environment settings (or a subset of the environment settings) can be selected and used in the second author's own drawing/model.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention. In summary, embodiments of the invention provide the ability to extract proprietary data in order that lighting and other environment settings can be used for a scene. Further using a standard image file format enables users to extract a particular environment setting based on a final rendering.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for utilizing scene elements in a computer drawing application comprising:
obtaining, in the computer drawing application, a modeling scene;
searching, using the computer drawing application, for a pattern scene,
wherein the pattern scene comprises an environment attribute;
selecting the pattern scene;
selecting, from the pattern scene, the environment attribute;
retrieving the selected environment attribute; and
using the retrieved selected environment attribute in the modeling scene.

2. The computer-implemented method of claim 1, wherein the searching comprises searching two or more general images on the Internet.

3. The computer-implemented method of claim 1, wherein the searching comprises:
displaying a pattern book containing a selected subset of images; and
searching the selected subset of images in the pattern book for the pattern scene.

4. The computer-implemented method of claim 1, wherein the selecting the environment attribute further comprises accepting input from a cursor control device.

5. The computer-implemented method of claim 1, further comprising:
establishing a working pattern palette comprising a subset of selected pattern scenes that is personalized to a user, wherein:
the searching searches the working pattern palette; and
the pattern scene is selected from the working pattern palette.

6. The computer-implemented method of claim 1, wherein the retrieving the environment attribute comprises dragging the attribute from the pattern scene into the modeling scene.

7. The computer-implemented method of claim 1, further comprising:
creating a second scene;
identifying the environment attribute in the second scene that is to be shared; and
rendering the second scene with a customized header;
wherein:
the customized header contains embedded information;
the embedded information enables the retrieving of the selected environment attribute;
the second scene is utilized as the pattern scene; and
geometry in the second scene that has not been identified to be shared is restricted from retrieval and use from the pattern scene.

8. The computer-implemented method of claim 1, wherein the environment attribute comprises a lighting setup.

9. The computer-implemented method of claim 1, wherein the environment attribute comprises a camera setting.

10. The computer-implemented method of claim 1, wherein the environment attribute comprises a background setting.

11. The computer-implemented method of claim 1, wherein the environment attribute comprises color information.

12. An apparatus for utilizing scene elements in a computer drawing application executing in a computer system comprising:
(a) a computer having a memory; and
(b) the computer drawing application executing on the computer, wherein the application is configured to:
(i) obtain a modeling scene;
(ii) search for a pattern scene, wherein the pattern scene comprises an environment attribute;
(iii) select the pattern scene;
(iv) select, from the pattern scene, the environment attribute;
(v) retrieve the selected environment attribute; and
(vi) use the retrieved selected environment attribute in the modeling scene.

13. The apparatus of claim 12, wherein the computer drawing application is configured to search by searching two or more general images on the Internet.

14. The apparatus of claim 12, wherein the computer drawing application is configured to search by:
displaying a pattern book containing a selected subset of images; and
searching the selected subset of images in the pattern book for the pattern scene.

15. The apparatus of claim 12, wherein the computer drawing application is configured to select the environment attribute by accepting input from a cursor control device.

16. The apparatus of claim 12, wherein the computer drawing application is further configured to:
establish a working pattern palette comprising a subset of selected pattern scenes that is personalized to a user, wherein:
the searching searches the working pattern palette; and
the pattern scene is selected from the working pattern palette.

17. The apparatus of claim 12, wherein the computer drawing application is configured to retrieve the environment attribute by dragging the attribute from the pattern scene into the modeling scene.

18. The apparatus of claim 12, wherein the computer drawing application is further configured to:
create a second scene;
identify the environment attribute in the second scene that is to be shared; and
render the second scene with a customized header;
wherein:
the customized header contains embedded information;
the embedded information enables the retrieving of the selected environment attribute;
the second scene is utilized as the pattern scene; and
geometry in the second scene that has not been identified to be shared is restricted from retrieval and use from the pattern scene.

19. The apparatus of claim 12, wherein the environment attribute comprises a lighting setup.

20. The apparatus of claim 12, wherein the environment attribute comprises a camera setting.

21. The apparatus of claim 12, wherein the environment attribute comprises a background setting.

22. The apparatus of claim 12, wherein the environment attribute comprises color information.
